(19) United States
(12) Patent Application Publication
(10) Pub. No.: US 2025/0233334 A1
(43) Pub. Date: Jul. 17, 2025

(54) PIN STRUCTURE AND ELECTRONIC DEVICE

(71) Applicant: Wistron NeWeb Corporation, Hsinchu (TW)

(72) Inventor: You-Hao XU, Hsinchu (TW)

(21) Appl. No.: 19/011,720

(22) Filed: Jan. 7, 2025

(30) Foreign Application Priority Data
Jan. 17, 2024 (TW) 113101847

(51) Int. Cl. H01R 13/04; H01R 12/58

(52) U.S. Cl. CPC H01R 13/04; H01R 12/58

(57) ABSTRACT

A pin structure includes an inserting element and a platform. The inserting element has an upper end and a lower end, and the upper end and the lower end are located along an axis. The platform is connected to the inserting element, and the platform is not parallel to the axis.

### RELATED APPLICATIONS

This application claims priority to Taiwan Application Serial Number 113101847, filed Jan. 17, 2024, which is herein incorporated by reference.

### BACKGROUND

### Technical Field

The present disclosure relates to a pin structure and an electronic device. More particularly, the present disclosure relates to a pin structure and an electronic device that can realize automatic mounting.

### Description of Related Art

Generally, in the conventional electronic device, a connection between an electronic element and a circuit board is established via a pin structure, so that the effect of positioning the electronic element and the conducting state of electricity can be achieved. However, the conventional pin structure is disposed on the circuit board by manual operation, and the conventional pin structure cannot be automatically mounted on the circuit board using an automated machine. Hence, the production efficiency of the electronic device is not ideal, and the production costs are increased due to the manual operation.

Therefore, how to develop a pin structure that can realize automatic mounting to enhance the production efficiency of the electronic device and decrease the production costs thereof has become a subject with economic value.

### SUMMARY

According to one aspect of the present disclosure, a pin structure includes an inserting element and a platform. The inserting element has an upper end and a lower end, wherein the upper end and the lower end are located along an axis. The platform is connected to the inserting element, wherein the platform is not parallel to the axis.

According to another aspect of the present disclosure, an electronic device includes a circuit board, a pin structure and an electronic element. The circuit board has a through hole. The pin structure is detachably connected to the circuit board and includes an inserting element and a platform. The inserting element has an upper end and a lower end, wherein the upper end and the lower end are located along an axis. The platform is connected to the inserting element, wherein the platform is not parallel to the axis, and the platform is for being picked up by a suction nozzle, so that the lower end of the inserting element is inserted into the through hole of the circuit board. The electronic element has an inserting hole, wherein the upper end is inserted into the inserting hole.

According to further another aspect of the present disclosure, a pin structure includes an inserting element. The inserting element has an upper end and a lower end, wherein the inserting element includes a platform. The platform is not parallel to an axis where the upper end is located, and the platform is located between the upper end and the lower end.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of a pin structure according to a first example of an embodiment of the present disclosure.

FIG. 2 is a side view of the pin structure of FIG. 1.

FIG. 3 is a front view of the pin structure of FIG. 1.

FIG. 4 is a bottom view of the pin structure of FIG. 1.

FIG. 5 is a three-dimensional schematic view of a pin structure according to a second example of the embodiment of the present disclosure.

FIG. 6 is a front view of the pin structure of FIG. 5.

FIG. 7 is a three-dimensional schematic view of a pin structure according to a third example of the embodiment of the present disclosure.

FIG. 8 is a front view of the pin structure of FIG. 7.

FIG. 9 is a three-dimensional schematic view of a pin structure according to a fourth example of the embodiment of the present disclosure.

FIG. 10 is a front view of the pin structure of FIG. 9.

FIG. 11 is a three-dimensional schematic view of a pin structure according to a fifth example of the embodiment of the present disclosure.

FIG. 12 is a front view of the pin structure of FIG. 11.

FIG. 13 is a three-dimensional schematic view of a pin structure according to a sixth example of the embodiment of the present disclosure.

FIG. 14 is a front view of the pin structure of FIG. 13.

FIG. 15 is a three-dimensional schematic view of a pin structure according to a seventh example of the embodiment of the present disclosure.

FIG. 16 is a front view of the pin structure of FIG. 15.

FIG. 17 is a three-dimensional schematic view of a pin structure according to an example of another embodiment of the present disclosure.

FIG. 18 is a front view of the pin structure of FIG. 17.

FIG. 19 is a schematic view of an electronic device according to an example of further another embodiment of the present disclosure.

FIG. 20 is a three-dimensional schematic view of the electronic device of FIG. 19.

FIG. 21 is a schematic view of a pin structure of the electronic device of FIG. 19 being picked and mounted to a circuit board by a suction nozzle.

FIG. 22 is a flow chart of a method for preparing pin structure according to an example of still another embodiment of the present disclosure.

FIG. 23 is a schematic view of a metal element used in a cutting step of the method for preparing pin structure of FIG. 22.

FIG. 24 is a schematic view of a metal structure prepared by the cutting step of the method for preparing pin structure of FIG. 22.

### DETAILED DESCRIPTION

The present disclosure will be further exemplified by the following specific embodiments. However, the embodiments can be applied to various inventive concepts and can be embodied in various specific ranges. The specific embodiments are only for the purposes of description and are not limited to these practical details thereof. Furthermore, in order to simplify the drawings, some conventional structures and elements will be illustrated in the drawings by a simple and schematic way. The duplicated elements may be denoted by the same number or similar numbers.

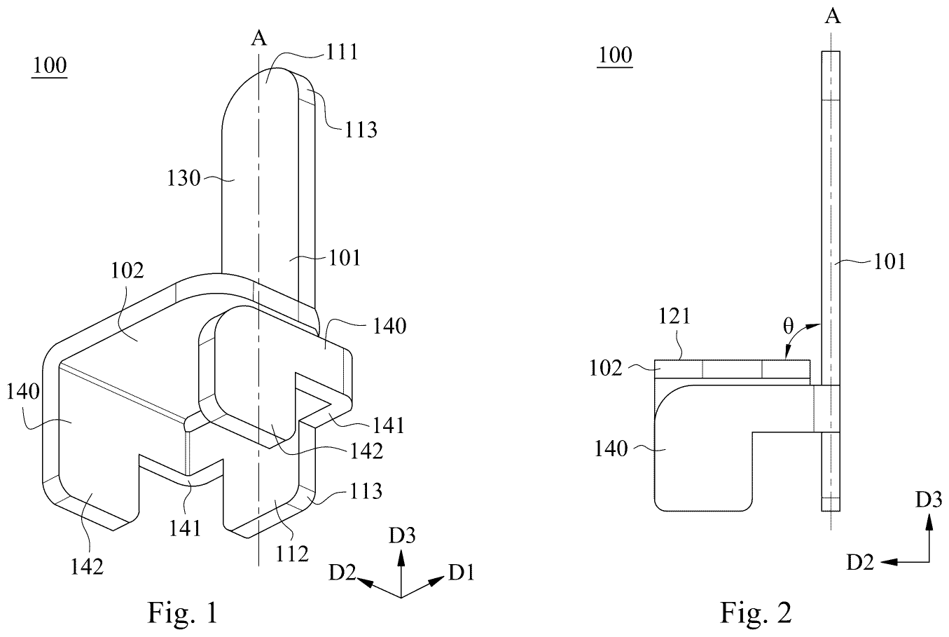

FIG. 1 is a three-dimensional schematic view of a pin structure 100 according to a first example of an embodiment of the present disclosure. In FIG. 1, the pin structure 100 includes an inserting element 101 and a platform 102.

The inserting element 101 has an upper end 111 and a lower end 112, wherein the upper end 111 and the lower end 112 are located along an axis A. Specifically, the upper end 111 can be inserted into an inserting hole of an electronic element (not shown), and the lower end 112 can be inserted into a through hole of a circuit board (not shown). Therefore, an electrical connection between the electronic element and the circuit board can be established via the inserting element 101.

The platform 102 is connected to the inserting element 101, and the platform 102 is not parallel to the axis A. Therefore, the platform 102 can be picked and placed by a suction nozzle (not shown) of an automated machine, so that the pin structure 100 can be positioned in the through hole of the circuit board, and the automatic mounting can be realized. Further, by arranging both of the upper end 111 and the lower end 112 along the same axis (axis A), there is no bending tolerance between the upper end 111 and the lower end 112, so that the risk of the upper end 111 being not precisely inserted into the inserting hole of the electronic element due to the bending tolerance can be avoided, or the risk of the lower end 112 being not precisely inserted into the through hole of the circuit board due to the bending tolerance can be avoided. Therefore, it is favorable for enhancing the positioning accuracy and the aligning accuracy of the pin structure 100 when the pin structure 100 is disposed on the electronic element and the circuit board.

FIG. 2 is a side view of the pin structure 100 of FIG. 1. As shown in FIG. 1 and FIG. 2, the inserting element 101 and the platform 102 can be integrally formed. The platform 102 has a plane 121, there is an included angle θ between the plane 121 and the axis A, and the included angle θ can be equal to 90 degrees. Therefore, the platform 102 can be stably picked and placed by the suction nozzle of the automated machine, and the pin structure 100 can be accurately positioned in the through hole of the circuit board. Further, the inserting element 101 and the platform 102 of the pin structure 100 can be integrally formed by cutting and then bending a metal plate, and the structural details of the pin structure 100 and the preparing method thereof will be further described in the following embodiment.

In FIG. 1, the inserting element 101 can include a plurality of chamfers 113, and each of the chamfers 113 is adjacent to one of the upper end 111 and the lower end 112 and is arc-shaped. Therefore, the lifetime of the pin structure 100 can be increased, the problem of the quality decline of the pin structure 100 due to rough edges can be reduced, and the inserting element 101 can be smoothly inserted into the inserting hole of the electronic element or the through hole of the circuit board by the guidance of the chamfers 113.

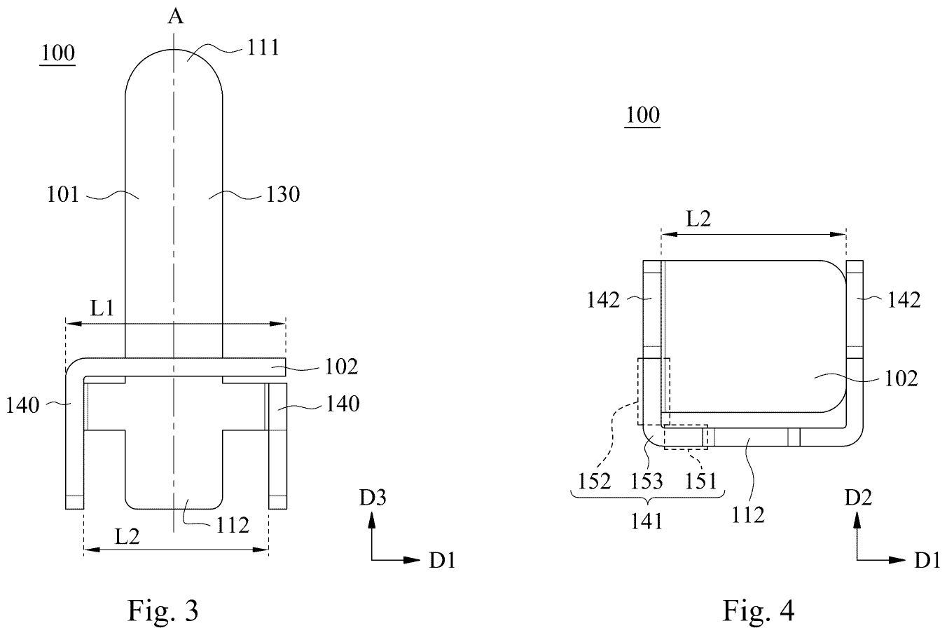

FIG. 3 is a front view of the pin structure 100 of FIG. 1, and FIG. 4 is a bottom view of the pin structure 100 of FIG. 1. As shown in FIG. 1 and FIG. 3, the inserting element 101 can include a mainbody 130 and two abutting portions 140. The mainbody 130 can be sheet-shaped and be parallel to the axis A, and the mainbody 130 has the upper end 111 and the lower end 112. The two abutting portions 140 are respectively and symmetrically connected to two sides of the mainbody 130, and any one of the two abutting portions 140 has an abutting surface 141. The abutting surface 141 is perpendicular to the axis A and is configured for abutting against the circuit board.

Specifically, in FIG. 1 and FIG. 4, the mainbody 130 and the two abutting portions 140 can be integrally formed, and the abutting surface 141 can include a first abutting area 151, a second abutting area 152 and a bending area 153. The first abutting area 151 extends toward a first axial direction D1, the second abutting area 152 extends toward a second axial direction D2, and the second axial direction D2 is perpendicular to the first axial direction D1. The bending area 153 is connected between the first abutting area 151 and the second abutting area 152. Therefore, the abutting surface 141 can be roughly L-shaped in appearance, and the structural stability of the pin structure 100 inserted into the circuit board can be enhanced.

As further shown in FIG. 1 to FIG. 4, the platform 102 has a platform length L1 along the first axial direction D1, and the platform 102 is connected to one of the two abutting portions 140. Two ends (its reference numeral is omitted) of the two abutting portions 140 face toward the second axial direction D2, and the axis A is parallel to a third axial direction D3. Any one of the two abutting portions 140 has an extending end 142 which faces toward the third axial direction D3, and the first axial direction D1, the second axial direction D2 and third axial direction D3 are perpendicular to each other.

In detail, the two abutting portions 140 are bent so that the two ends of the two abutting portions 140 extend toward the second axial direction D2, and the platform length L1 can be greater than a space distance L2 between the two ends of the two abutting portions 140. Therefore, the platform 102 can be abutted against another one of the two abutting portions 140 when the platform 102 is pressed by a loading, so that the risks of the deformation of the platform 102 and the breakage thereof can be avoided, and the structural stability of the pin structure 100 can be enhanced.

Further, in the first example of FIG. 1 to FIG. 4, both of the two abutting portions 140 have the extending ends 142, and the two extending ends 142 extend from the two ends of the two abutting portions 140 toward the third axial direction D3, so that the pin structure 100 is roughly chair-shaped in appearance. Therefore, the structural stability of the pin structure 100 can be enhanced. Further, the two extending ends 142 can be inserted into the through holes of the circuit board along with the lower end 112, so that one side of the pin structure 100 can have the ability to conduct electricity at three terminals. Hence, the conductivity of the pin structure 100 can be enhanced, and the safety in use thereof can also be enhanced.

Therefore, by the arrangements that the upper end 111 and the lower end 112 are located along the axis A, and the platform 102 is not parallel to the axis A, the platform 102 of the pin structure 100 of the present disclosure can be picked and placed by the suction nozzle of the automated machine so as to realize the automatic mounting. At the same time, there is no bending tolerance between the upper end 111 and the lower end 112, and the upper end 111 and the lower end 112 can be accurately and respectively inserted into the inserting hole of the electronic element and the through hole of the circuit board so as to establish the electrical connection between the electronic element and the circuit board. Further, by the arrangements that the inserting element 101 includes the abutting portions 140, and the abutting portions 140 have the extending ends 142, the structural stability, conductivity and the safety in use of the pin structure 100 can be enhanced.

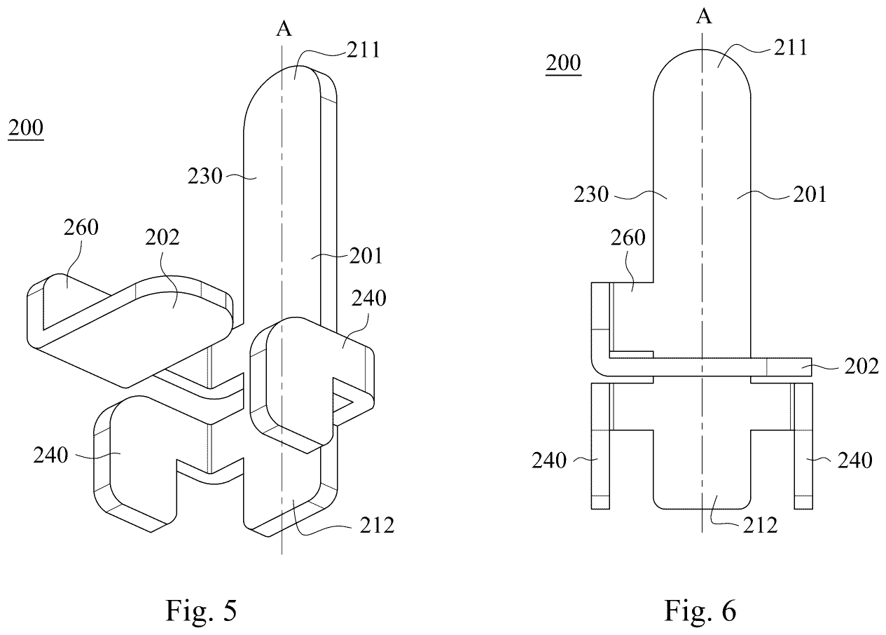

FIG. 5 is a three-dimensional schematic view of a pin structure 200 according to a second example of the embodiment of the present disclosure. FIG. 6 is a front view of the pin structure 200 of FIG. 5. In FIG. 5 and FIG. 6, the pin structure 200 includes an inserting element 201 and a platform 202. A difference between the pin structure 200 of the second example and the pin structure 100 of the first example is that the inserting element 201 further includes a platform connecting portion 260, and the platform 202 is connected to the inserting element 201 via the platform connecting portion 260. The difference between the pin structure 200 and the pin structure 100 will be described below, and the same features will not be described again herein.

Specifically, the platform connecting portion 260 is connected between the platform 202 and a mainbody 230, and the platform connecting portion 260 is closer to an upper end 211 than two abutting portions 240 to the upper end 211. Further, the platform connecting portion 260 can be integrally connected to the platform 202 and the mainbody 230, and the platform connecting portion 260 is bent so that one end of the platform connecting portion 260 faces toward an extending direction of two ends of the two abutting portions 240. The extending direction is perpendicular to an axis A. Furthermore, the platform 202 is integrally connected to one side of the platform connecting portion 260 close to a lower end 212. Therefore, there is an appropriate distance between the inserting element 201 and the platform 202, so that the pin structure 200 can be applied to different automated machines, and different usage requirements can be satisfied.

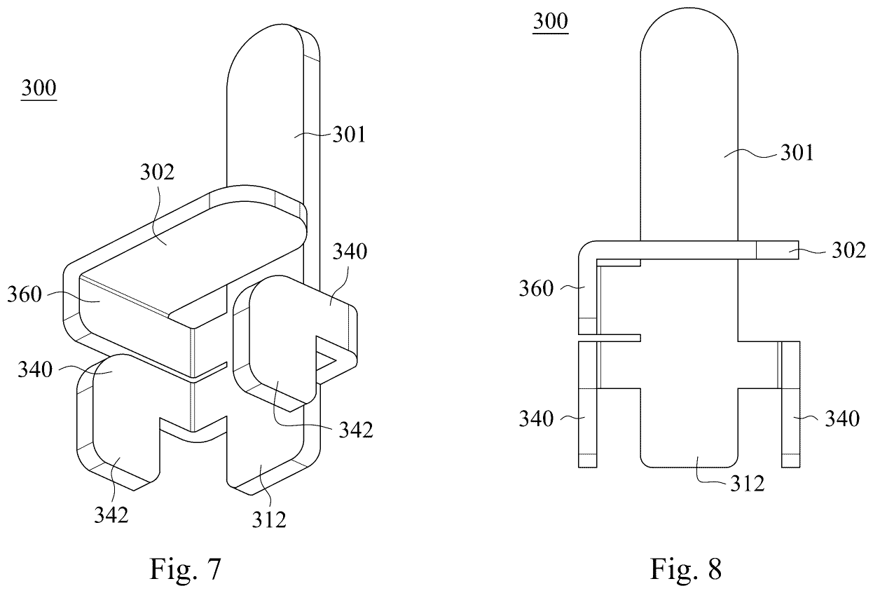

FIG. 7 is a three-dimensional schematic view of a pin structure 300 according to a third example of the embodiment of the present disclosure. FIG. 8 is a front view of the pin structure 300 of FIG. 7. In FIG. 7 and FIG. 8, the pin structure 300 includes an inserting element 301 and a platform 302. The pin structure 300 of the third example is similar to the pin structure 200 of the second example, and a difference between the pin structure 300 and the pin structure 200 is the location where the platform 302 is connected to a platform connecting portion 360. The difference between the pin structure 300 and the pin structure 200 will be described below, and the same features will not be described again herein.

Specifically, in the pin structure 300, the platform 302 is integrally connected to one side of the platform connecting portion 360 away from a lower end 312 of the inserting element 301, so that the platform 302 can be located along an extending direction of two extending ends 342 of two abutting portions 340. Therefore, it is favorable for enhancing the structural stability of the pin structure 300.

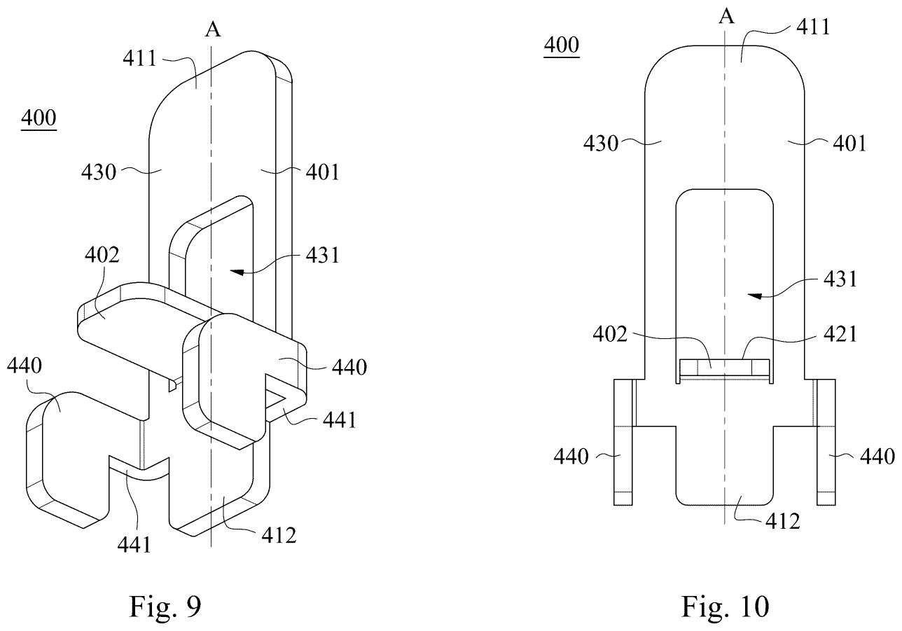

FIG. 9 is a three-dimensional schematic view of a pin structure 400 according to a fourth example of the embodiment of the present disclosure. FIG. 10 is a front view of the pin structure 400 of FIG. 9. In FIG. 9 and FIG. 10, the pin structure 400 includes an inserting element 401 and a platform 402.

The inserting element 401 has an upper end 411 and a lower end 412, and the upper end 411 and the lower end 412 are located along an axis A. The platform 402 is connected to the inserting element 401, and the platform 402 is not parallel to the axis A. In detail, the inserting element 401 includes a mainbody 430 and two abutting portions 440. The mainbody 430 is sheet-shaped and has a penetrating hole 431, the upper end 411 and the lower end 412. The mainbody 430 is parallel to the axis A and is connected to the platform 402, and an area of the penetrating hole 431 is larger than or equal to an area of the platform 402. The two abutting portions 440 are respectively and symmetrically connected to two sides of the mainbody 430.

Further, the platform 402 is formed by bending a part of the mainbody 430, so that a plane 421 (as labeled in FIG. 10) of the platform 402 is roughly perpendicular to the axis A. As further shown in FIG. 9, a shape of the penetrating hole 431 can be corresponded to a shape of the platform 402, and it is favorable for simplifying the manufacturing processes of the pin structure 400, but the present disclosure is not limited thereto. Further, although it is not shown in the figures, in other examples, the shape of the penetrating hole of the mainbody can be different from the shape of the platform. For example, the penetrating hole can be roughly rectangle, and the platform can be roughly mushroom-shaped, etc., so that the different usage requirements can be satisfied, but the present disclosure is not limited thereto.

Furthermore, the inserting element 401 further has two abutting surfaces 441, and the two abutting surfaces 441 are formed by the mainbody 430 and the two abutting portions 440. Any one of the two abutting surfaces 441 is perpendicular to the axis A and is L-shaped, and the two abutting surfaces 441 is configured for abutting against the circuit board. Moreover, the abutting surfaces 441 are similar in the structures of the abutting surfaces 141 of the first example of FIG. 1, so that the details of the same elements are not described herein.

Therefore, the platform 402 of the pin structure 400 can be picked up by the suction nozzle of the automated machine so as to realize the automatic mounting, and the structural stability of the pin structure 400 and the safety in use thereof can be enhanced. Further, by arranging both of the upper end 411 and the lower end 412 of the inserting element 401 along the axis A, there is no bending tolerance between the upper end 411 and the lower end 412 of the inserting element 401, and it is favorable for enhancing the positioning accuracy and the aligning accuracy of the pin structure 400 when the pin structure 400 is disposed on the electronic element and the circuit board.

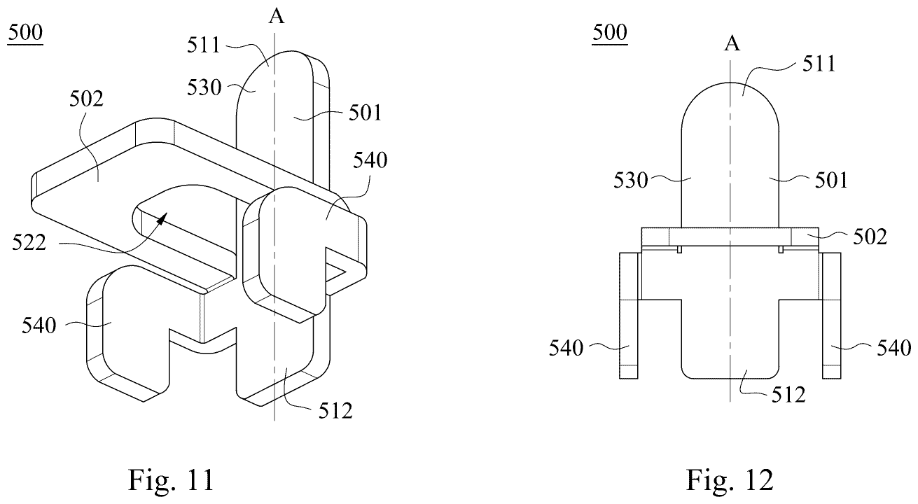

FIG. 11 is a three-dimensional schematic view of a pin structure 500 according to a fifth example of the embodiment of the present disclosure. FIG. 12 is a front view of the pin structure 500 of FIG. 11. In FIG. 11 and FIG. 12, the pin structure 500 includes an inserting element 501 and a platform 502. The pin structure 500 of the fifth example is similar to the pin structure 400 of the fourth example, and the differences between the pin structure 500 and the pin structure 400 are the shapes of the platform 502 and the platform 402. The differences between the pin structure 500 and the pin structure 400 will be described below, and the same features will not be described again herein.

In detail, the inserting element 501 includes a mainbody 530 and two abutting portions 540. The mainbody 530 is sheet-shaped and has an upper end 511 and a lower end 512, and the mainbody 530 is parallel to an axis A and is connected to the platform 502. An area of a penetrating hole 522 of the platform 502 is larger than or equal to an area of the upper end 511, and the area of the upper end 511 is the range of the mainbody 530 from an end point of the upper end 511 to one side of the platform 502 facing toward the lower end 512. The two abutting portions 540 are respectively and symmetrically connected to two sides of the mainbody 530. Further, in the fifth example of FIG. 11, the platform 502 is bent so that it is roughly perpendicular to the axis A, and the penetrating hole 522 is formed by a part of the platform 502 corresponding to the mainbody 530.

Therefore, the platform 502 of the pin structure 500 can be picked up by the suction nozzle of the automated machine so as to realize the automatic mounting, and the different usage requirements can be satisfied.

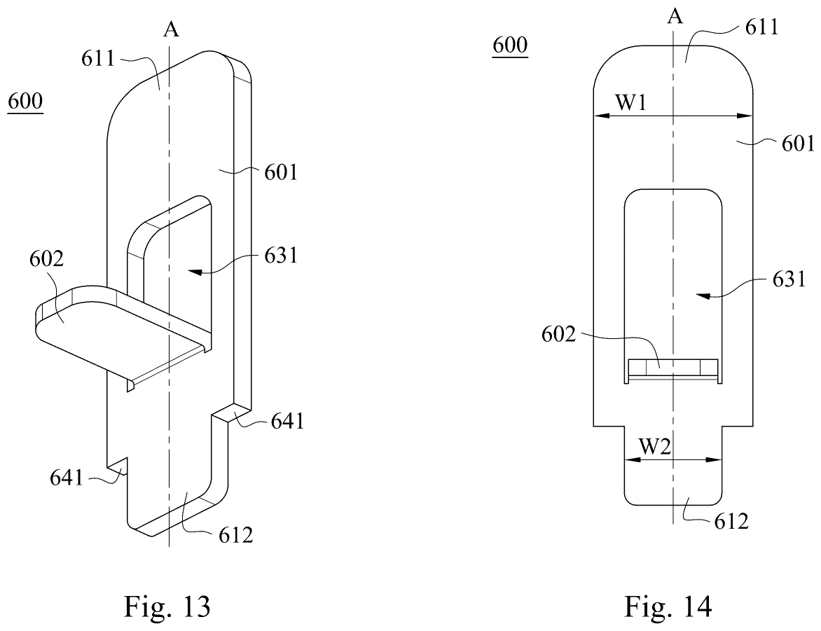

FIG. 13 is a three-dimensional schematic view of a pin structure 600 according to a sixth example of the embodiment of the present disclosure. FIG. 14 is a front view of the pin structure 600 of FIG. 13. In FIG. 13 and FIG. 14, the pin structure 600 includes an inserting element 601 and a platform 602.

The inserting element 601 has an upper end 611 and a lower end 612, and the upper end 611 and the lower end 612 are located along an axis A. The platform 602 is connected to the inserting element 601, and the platform 602 is not parallel to the axis A. In specific, the inserting element 601 has two abutting surfaces 641, and any one of the two abutting surfaces 641 is perpendicular to the axis A and is square. The inserting element 601 is sheet-shaped and has a penetrating hole 631, and an area of the penetrating hole 631 is larger than or equal to an area of the platform 602. Further, the upper end 611 has a first width W1, the lower end 612 has a second width W2, and the first width W1 is larger than the second width W2. Furthermore, the platform 602 is formed by bending a part of the inserting element 601, and the two abutting surfaces 641 of the inserting element 601 are for abutting against the circuit board. Therefore, the platform 602 can be picked up by the suction nozzle of the automated machine so as to realize the automatic mounting, and the different usage requirements can be satisfied. Further, by arranging both of the upper end 611 and the lower end 612 of the inserting element 601 along the axis A, there is no bending tolerance between the upper end 611 and the lower end 612 of the inserting element 601, and it is favorable for enhancing the positioning accuracy and the aligning accuracy of the pin structure 600 when the pin structure 600 is disposed on the electronic element and the circuit board.

Furthermore, a shape of the penetrating hole 631 can be corresponded to a shape of the platform 602, and it is favorable for simplifying the manufacturing processes of the pin structure 600, but the present disclosure is not limited thereto. Moreover, although it is not shown in the figures, in other examples, the shape of the penetrating hole of the inserting element can be different from the shape of the platform. For example, the penetrating hole can be roughly rectangle, and the platform can be roughly mushroom-shaped, etc., so that the different usage requirements can be satisfied, but the present disclosure is not limited thereto.

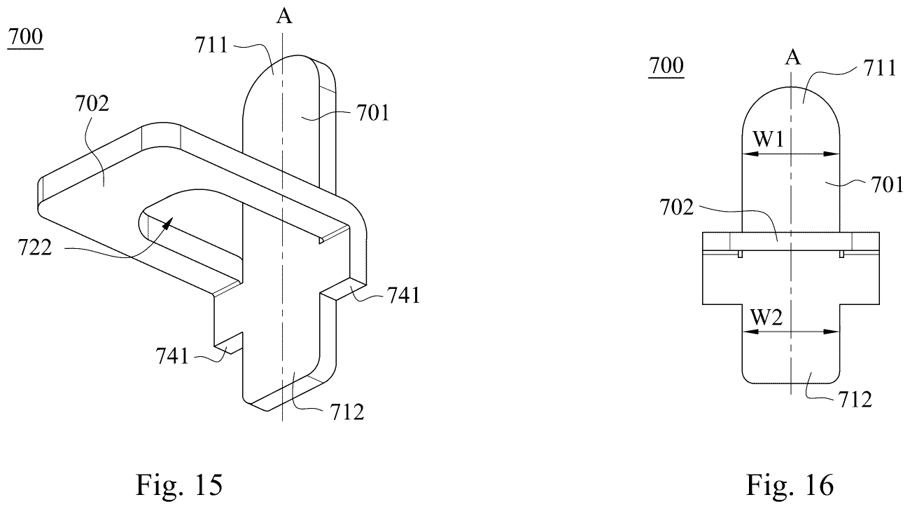

FIG. 15 is a three-dimensional schematic view of a pin structure 700 according to the seventh example of the embodiment of the present disclosure. FIG. 16 is a front view of the pin structure 700 of FIG. 15. In FIG. 15 and FIG. 16, the pin structure 700 includes an inserting element 701 and a platform 702. A difference between the pin structure 700 of the seventh example and the pin structure 500 of the fifth example is that the inserting element 701 does not include two abutting portions. The difference between the pin structure 700 and the pin structure 500 will be described below, and the same features will not be described again herein.

Specifically, the inserting element 701 has two abutting surfaces 741, and any one of the two abutting surfaces 741 is perpendicular to the axis A and is square. An area of a penetrating hole 722 of the platform 702 is larger than or equal to an area of an upper end 711 of the inserting element 701, and the area of the upper end 711 is the range of the inserting element 701 from an end point of the upper end 711 to one side of the platform 702 facing toward the lower end 712. Further, the upper end 711 has a first width W1, the lower end 712 has a second width W2, and the first width W1 is equal to the second width W2. Therefore, the direction in which the pin structure 700 is inserted into the circuit board and the electronic element is not limited to that described in the aforementioned paragraph, and the pin structure 700 can be inserted into the inserting hole of the electronic element by the lower end 712 thereof and inserted into the through hole of the circuit board by the upper end 711 thereof, so that the breadth of applications of the pin structure 700 can be enhanced. Further, the platform 702 can be picked up by the suction nozzle of the automated machine so as to realize the automatic mounting, and the different usage requirements can be satisfied.

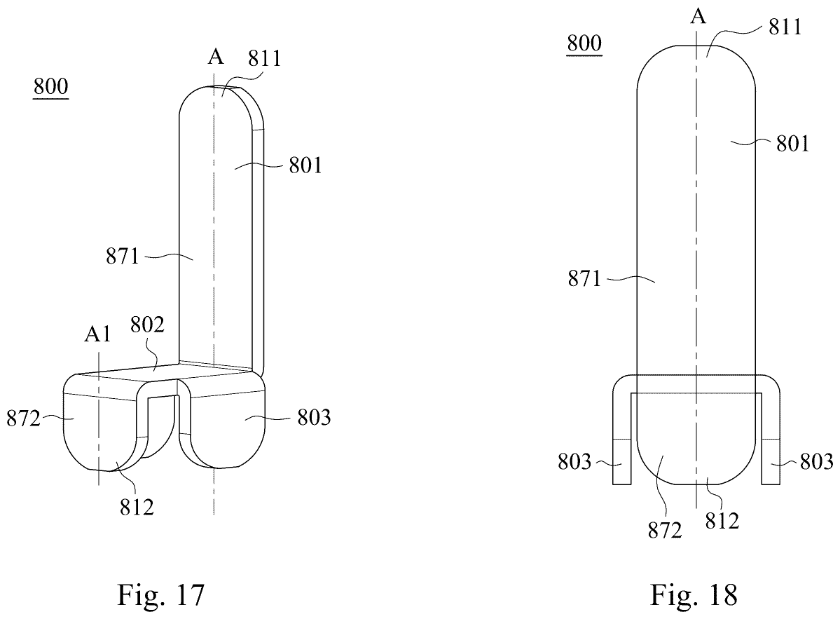

FIG. 17 is a three-dimensional schematic view of a pin structure 800 according to an example of another embodiment of the present disclosure. FIG. 18 is a front view of the pin structure 800 of FIG. 17. In FIG. 17 and FIG. 18, the pin structure 800 includes an inserting element 801 and two extending elements 803.

The inserting element 801 has an upper end 811 and a lower end 812. The upper end 811 is located along an axis A, the lower end 812 is located along another axis A1, and the axis A is parallel to the axis A1. The inserting element 801 includes a platform 802, a first plate portion 871 and a second plate portion 872, and the platform 802, the first plate portion 871 and the second plate portion 872 are connected to each other. Further, the first plate portion 871 has the upper end 811, the second plate portion 872 has the lower end 812, the platform 802 is not parallel to the axis A where the upper end 811 is located, and the platform 802 is located between the upper end 811 and the lower end 812.

In detail, the inserting element 801 is bent twice to form the platform 802, the first plate portion 871 and the second plate portion 872, and the first plate portion 871 and the second plate portion 872 are respectively connected to opposite sides of the platform 802. Further, a plane (its reference numeral is omitted) of the platform 802 is roughly perpendicular to the axis A and the axis A1, so that the platform 802 can be stably picked up by the suction nozzle of the automated machine, and the pin structure 800 can be accurately positioned in the through hole of the circuit board. It should be mentioned that the upper end 811 of the first plate portion 871 and the lower end 812 of the second plate portion 872 are not located along the same axis after the inserting element 801 is bent twice. In other words, only the upper end 811 of the first plate portion 871 is located along the axis A.

The two extending elements 803 are connected to other two sides of the inserting element 801 and are symmetrical to each other. In specific, the two extending elements 803 are respectively and integrally connected to two sides of the platform 802 different from the first plate portion 871 and the second plate portion 872, so that the pin structure 800 is roughly chair-shaped in appearance. Therefore, the second plate portion 872 of the inserting element 801 can be inserted into the through hole of the circuit board along with the two extending elements 803, so that one side of the pin structure 800 can have the ability to conduct electricity at three terminals. Hence, the conductivity of the pin structure 800 can be enhanced, and the safety in use thereof can also be enhanced.

Therefore, by the arrangements that the inserting element 801 includes the platform 802, the platform 802 is not parallel to the axis A, and the platform 802 is located between the upper end 811 and the lower end 812, the platform 802 of the pin structure 800 of the present disclosure can be picked up by the suction nozzle of the automated machine so as to realize the automatic mounting, and it is favorable for reducing the manufacturing costs of the pin structure 800.

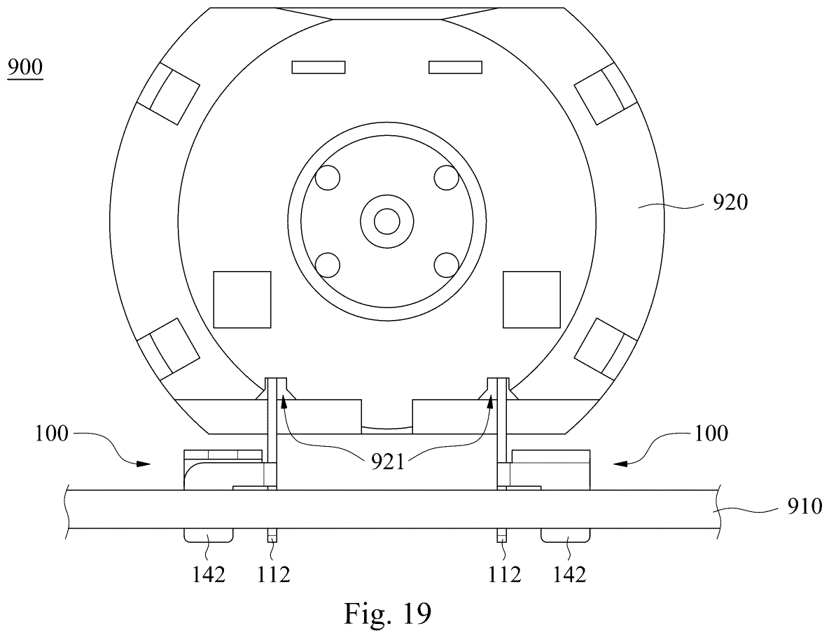

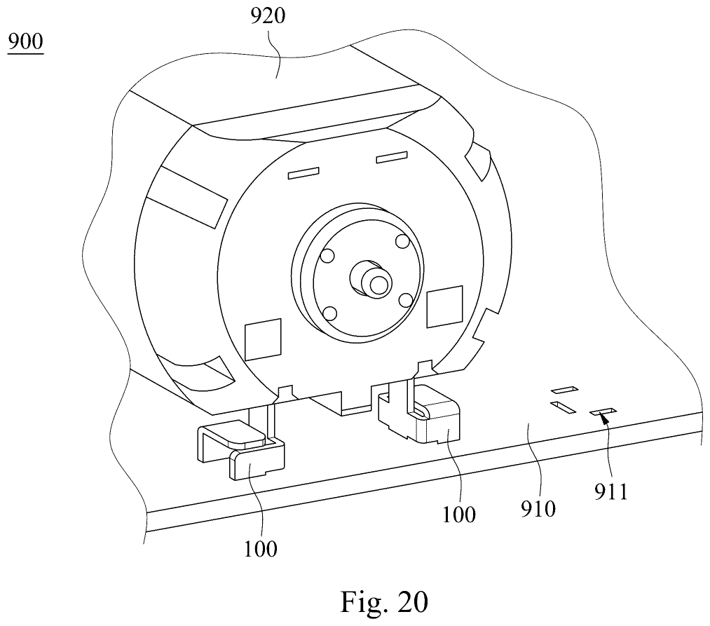

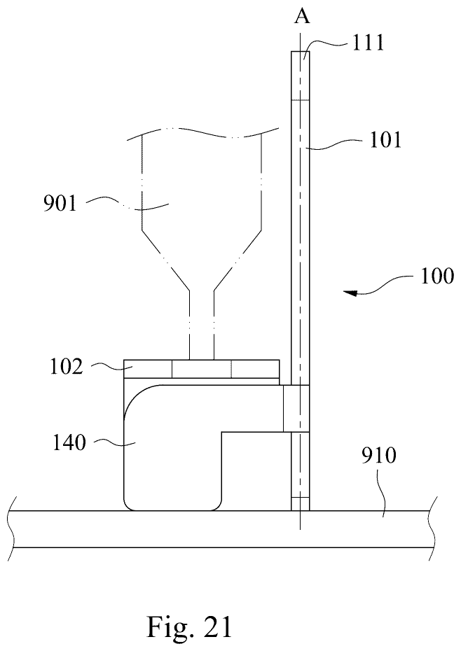

FIG. 19 is a schematic view of an electronic device 900 according to an example of further another embodiment of the present disclosure. FIG. 20 is a three-dimensional schematic view of the electronic device 900 of FIG. 19. FIG. 21 is a schematic view of a pin structure 100 of the electronic device 900 of FIG. 19 being picked and mounted to a circuit board 910 by a suction nozzle 901. In FIG. 19 to FIG. 21, the electronic device 900 is configured for realizing an automatic mounting by the suction nozzle 901, and the electronic device 900 includes the circuit board 910, the pin structure 100 and an electronic element 920, wherein the pin structure 100 is the pin structure 100 of FIG. 1, so that the structural details thereof will not be described again herein.

The circuit board 910 has at least one through hole 911. Specifically, in the example of FIG. 19 to FIG. 21, the circuit board 910 has a plurality of through holes 911, the plurality of through holes 911 are separately arranged on the circuit board 910, and a pin can be inserted into each of the plurality of through holes 911.

The pin structure 100 is detachably connected to the circuit board 910, and the platform 102 of the pin structure 100 is for being picked by the suction nozzle 901, so that the lower end 112 of the inserting element 101 can be inserted into the through hole 911 of the circuit board 910. In detail, as shown in FIG. 19 and FIG. 21, the platform 102 can be picked up by the suction nozzle 901, and then the pin structure 100 is mounted to the circuit board 910, so that the lower end 112 of the inserting element 101 and the two extending ends 142 of the two abutting portions 140 are inserted into the plurality of the through holes 911 of the circuit board 910. Further, in the example of FIG. 19 and FIG. 20, a number of the pin structure 100 is two, and the two pin structures 100 are symmetrically disposed on the circuit board 910. Therefore, it is favorable for defining a positive electrode and a negative electrode, and the conducting state of electricity can be achieved.

The electronic element 920 has an inserting hole 921, and the upper end 111 (as labeled in FIG. 21) of the inserting element 101 is inserted into the inserting hole 921. In specific, as shown in FIG. 19 and FIG. 20, after the two pin structures 100 are picked up by the suction nozzle 901 and then mounted to the circuit board 910, the upper end 111 of the inserting element 101 of each of the two pin structures 100 will face toward one side of the inserting element 101 away from the circuit board 910. At the same time, the electronic element 920 can be inserted into the two upper ends 111, and the electrical connection can be established.

Further, in other examples, the pin structure 100 of the electronic device 900 of FIG. 19 to FIG. 21 can be replaced by the pin structure of any one of the examples of the aforementioned embodiment, so that the different usage requirements can be satisfied.

Therefore, by the arrangements of the electronic device 900 of the present disclosure including the pin structure 100, and the platform 102 of the pin structure 100 being not parallel to the axis A, the platform 102 can be picked up by the suction nozzle 901, so that the pin structure 100 can be mounted to the circuit board 910, and the automatic mounting (pick and place) can be realized. Further, the production efficiency of the electronic device 900 can be enhanced, the production costs thereof can be reduced, and the production yield of the electronic device 900 can be enhanced.

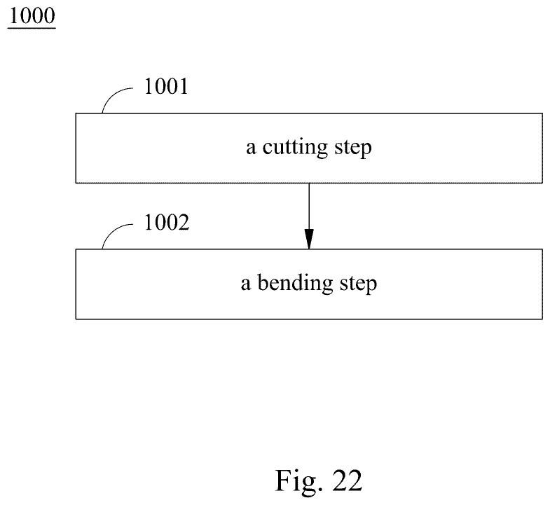

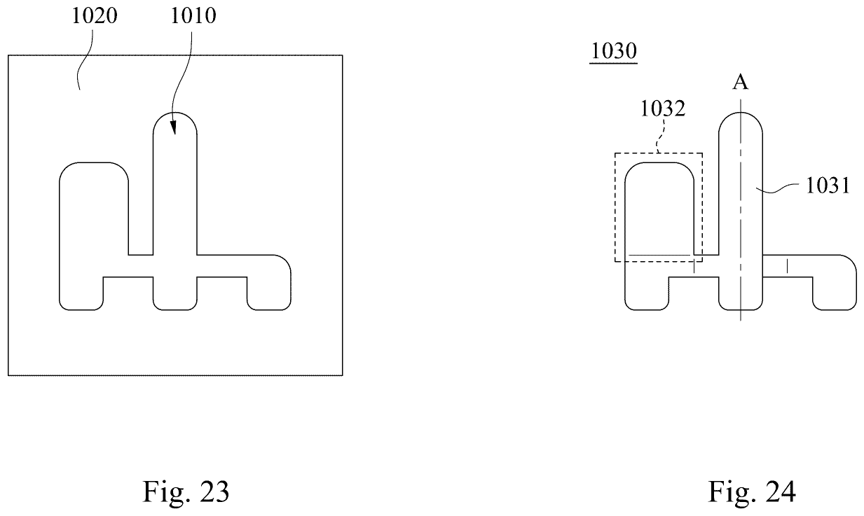

FIG. 22 is a flow chart of a method for preparing pin structure 1000 according to an example of still another embodiment of the present disclosure. FIG. 23 is a schematic view of a metal element 1020 used in a cutting step 1001 of the method for preparing pin structure 1000 of FIG. 22. FIG. 24 is a schematic view of a metal structure 1030 prepared by the cutting step 1001 of the method for preparing pin structure 1000 of FIG. 22. In FIG. 22 to FIG. 24, the method for preparing pin structure 1000 includes the cutting step 1001 and a bending step 1002.

In the cutting step 1001, a metal structure 1030 is obtained by a first device driven to cut the metal element 1020 according to a pattern 1010. Specifically, the metal structure 1030 is sheet-shaped, and an axis A can be defined by the metal structure 1030. Further, the metal structure 1030 includes a first metal portion 1031 and a second metal portion 1032, and the first metal portion 1031 is integrally connected to the second metal portion 1032.

In the bending step 1002, the metal structure 1030 is bent by a second device according to the pattern 1010, so that a pin structure 100 (as labeled in FIG. 1) is formed by the metal structure 1030. The details of the pin structure 100 are described in the aforementioned paragraph, so that the details thereof will not be described again herein.

As shown in FIG. 1 and FIG. 24, in the bending step 1002, the first metal portion 1031 and the second metal portion 1032 are bent by the second device according to the pattern 1010, so that the inserting element 101 is formed by the first metal portion 1031, and the platform 102 is formed by the second metal portion 1032. Therefore, the inserting element 101 and the platform 102 are integrally formed, and it is favorable for simplifying the manufacturing processes of the pin structure 100.

According to the above, the advantages of the pin structure, the electronic device and the method for preparing pin structure of the present disclosure are shown as below.

First, in the present disclosure, the platform is not parallel to the axis, thus the platform of the pin structure can be picked up by the suction nozzle of the automated machine so as to realize the automatic mounting.

Second, by arranging both of the upper end and the lower end of the inserting element of the pin structure along the axis, there is no bending tolerance between the upper end and the lower end of the inserting element, and it is favorable for enhancing the positioning accuracy and the aligning accuracy of the pin structure when the pin structure is disposed on the electronic element and the circuit board.

Third, by the arrangements that the inserting element includes the abutting portion, and the abutting portion has the extending end, the structural stability, conductivity and safety in use of the pin structure can be enhanced. Further, by the arrangements that the inserting element includes the platform connecting portion, the area of the penetrating hole of the mainbody is larger than or equal to the area of the platform, or the area of the penetrating hole of the platform is larger than or equal to the area of the upper end, the different usage requirements can be satisfied on the premise of realizing the automatic mounting.

Fourth, by the arrangement of the electronic device of the present disclosure including the pin structure of the present disclosure, the automatic mounting can be realized by the suction nozzle of the automated machine, so that the production efficiency and the production yields of the electronic device can be enhanced, and the production costs thereof can be reduced.

Fifth, by the arrangement that the pin structure is prepared by the method for preparing pin structure of the present disclosure, the pin structure can have excellent structural stability, and the automatic mounting can be realized. Therefore, the pin structure, the electronic device and the method for preparing pin structure of the present disclosure have the application potentials in the relevant market.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pin structure, comprising:
an inserting element having an upper end and a lower end, wherein the upper end and the lower end are located along an axis; and
a platform connected to the inserting element, wherein the platform is not parallel to the axis.

2. The pin structure of claim 1, wherein the inserting element and the platform are integrally formed, the platform has a plane, there is an included angle between the plane and the axis, and the included angle is equal to 90 degrees.

3. The pin structure of claim 1, wherein the inserting element comprises:
a mainbody, wherein the mainbody is sheet-shaped and is parallel to the axis, and the mainbody has the upper end and the lower end; and
two abutting portions respectively and symmetrically connected to two sides of the mainbody, wherein any one of the two abutting portions has an abutting surface, and the abutting surface is perpendicular to the axis.

4. The pin structure of claim 3, wherein the mainbody and the two abutting portions are integrally formed, and the abutting surface comprises:
a first abutting area extending toward a first axial direction;
a second abutting area extending toward a second axial direction, wherein the second axial direction is perpendicular to the first axial direction; and
a bending area connected between the first abutting area and the second abutting area.

5. The pin structure of claim 3, wherein the platform has a platform length along a first axial direction, the platform is connected to one of the two abutting portions, two ends of the two abutting portions face toward a second axial direction, the axis is parallel to a third axial direction, any one of the two abutting portions has an extending end which faces toward the third axial direction, and the first axial direction, the second axial direction and the third axial direction are perpendicular to each other.

6. The pin structure of claim 3, wherein the inserting element further comprises:
a platform connecting portion connected between the platform and the mainbody, wherein the platform connecting portion is closer to the upper end than the two abutting portions to the upper end.

7. The pin structure of claim 1, wherein the inserting element comprises:
a mainbody, wherein the mainbody is sheet-shaped and has a penetrating hole, the upper end and the lower end, the mainbody is parallel to the axis and is connected to the platform, and an area of the penetrating hole is larger than or equal to an area of the platform; and
two abutting portions respectively and symmetrically connected to two sides of the mainbody.

8. The pin structure of claim 1, wherein the inserting element comprises:
a mainbody, wherein the mainbody is sheet-shaped and has the upper end and the lower end, the mainbody is parallel to the axis and is connected to the platform, and an area of a penetrating hole of the platform is larger than or equal to an area of the upper end; and
two abutting portions respectively and symmetrically connected to two sides of the mainbody.

9. The pin structure of claim 1, wherein the inserting element has two abutting surfaces, any one of the two abutting surfaces is perpendicular to the axis and is square, the inserting element is sheet-shaped and has a penetrating hole, an area of the penetrating hole is larger than or equal to an area of the platform, the upper end has a first width, the lower end has a second width, and the first width is larger than the second width.

10. The pin structure of claim 1, wherein the inserting element has two abutting surfaces, any one of the two abutting surfaces is perpendicular to the axis and is square, an area of a penetrating hole of the platform is larger than or equal to an area of the upper end of the inserting element, the upper end has a first width, the lower end has a second width, and the first width is equal to the second width.

11. An electronic device comprising:
a circuit board having a through hole;
a pin structure detachably connected to the circuit board and comprising:
an inserting element having an upper end and a lower end, wherein the upper end and the lower end are located along an axis; and
a platform connected to the inserting element, wherein the platform is not parallel to the axis, and the platform is for being picked up by a suction nozzle, so that the lower end of the inserting element is inserted into the through hole of the circuit board; and
an electronic element having an inserting hole, wherein the upper end is inserted into the inserting hole.

12. The electronic device of claim 11, wherein the inserting element and the platform are integrally formed, the platform has a plane, there is an included angle between the plane and the axis, and the included angle is equal to 90 degrees.

13. The electronic device of claim 11, wherein the inserting element comprises:
a mainbody, wherein the mainbody is sheet-shaped and is parallel to the axis, and the mainbody has the upper end and the lower end; and
two abutting portions respectively and symmetrically connected to two sides of the mainbody, wherein any one of the two abutting portions has an abutting surface, and the abutting surface is perpendicular to the axis and is for abutting against the circuit board.

14. The electronic device of claim 13, wherein the mainbody and the two abutting portions are integrally formed, and the abutting surface comprises:
a first abutting area extending toward a first axial direction;
a second abutting area extending toward a second axial direction, wherein the second axial direction is perpendicular to the first axial direction; and
a bending area connected between the first abutting area and the second abutting area.

15. The electronic device of claim 13, wherein the platform has a platform length along a first axial direction, the platform is connected to one of the two abutting portions, two ends of the two abutting portions face toward a second axial direction, the axis is parallel to a third axial direction, any one of the two abutting portions has an extending end, the circuit board further has another one through hole, the extending end faces toward the third axial direction and is for being inserted into the another one through hole, and the first axial direction, the second axial direction and the third axial direction are perpendicular to each other.

16. The electronic device of claim 13, wherein the inserting element further comprises:
a platform connecting portion connected between the platform and the mainbody, wherein the platform connecting portion is closer to the upper end than the two abutting portions to the upper end.

17. The electronic device of claim 11, wherein the inserting element has two abutting surfaces, the two abutting surfaces are for abutting against the circuit board, and the inserting element comprises:
a mainbody, wherein the mainbody is sheet-shaped and has a penetrating hole, the upper end and the lower end, the mainbody is parallel to the axis and is connected to the platform, and an area of the penetrating hole is larger than or equal to an area of the platform; and
two abutting portions respectively and symmetrically connected to two sides of the mainbody.

18. The electronic device of claim 11, wherein the inserting element has two abutting surfaces, the two abutting surfaces are for abutting against the circuit board, and the inserting element comprises:
a mainbody, wherein the mainbody is sheet-shaped and has the upper end and the lower end, the mainbody is parallel to the axis and is connected to the platform, and an area of a penetrating hole of the platform is larger than or equal to an area of the upper end; and
two abutting portions respectively and symmetrically connected to two sides of the mainbody.

19. A pin structure, comprising:
an inserting element having an upper end and a lower end, wherein the inserting element comprises:
a platform, wherein the platform is not parallel to an axis where the upper end is located, and the platform is located between the upper end and the lower end.

20. The pin structure of claim 19, further comprising:
two extending elements connected to the inserting element.
